(19) United States
(12) Patent Application Publication
(10) Pub. No.: US 2026/0308948 A1
(43) Pub. Date: Oct. 8, 2026

(54) AUTOMOTIVE BOWDEN CABLE DEVICE

(71) Applicant: Kiekert Aktiengesellschaft, Heiligenhaus (DE)

(72) Inventors: Robert Hunt, Davisburg, MI (US); Bryan Bishop, Howell, MI (US)

(73) Assignee: Kiekert Aktiengesellschaft, Heiligenhaus (DE)

(21) Appl. No.: 19/097,916

(22) Filed: Apr. 2, 2025

(51) Int. Cl. E05B 79/20

(52) U.S. Cl. CPC E05B 79/20

(57) ABSTRACT

An automotive Bowden cable device for mechanically coupling an actuating element, for example a motor vehicle door handle, to a functional housing. The functional housing is, for example, a motor vehicle latch housing. The device has a Bowden cable having a core and a sheath and a Bowden cable end piece for the sealed coupling of the Bowden cable to the functional housing. The Bowden cable end piece, is equipped with an inner guide for a core end piece of the Bowden cable. During the installation of the Bowden cable end piece, the core end piece engages over an upright end of a lever protruding from the functional housing in the region of an insertion opening of the Bowden cable in the functional housing. According to the invention, the inner guide in the Bowden cable end piece is designed as a constrained guide that acts on both sides of the core end piece and prevents rotation.

The invention relates to an automotive Bowden cable device for mechanically coupling an actuating element, for example a motor vehicle door handle, to a functional housing, for example a motor vehicle latch housing, comprising a Bowden cable having a core and a sheath, and comprising a Bowden cable end piece for sealed coupling to the functional housing, the Bowden cable end piece having an inner guide for a core end piece of the Bowden cable, and the core end piece engaging over an upright end of a lever protruding from the functional housing in the region of an insertion opening of the Bowden cable in the functional housing during the installation of the Bowden cable end piece.

Automotive Bowden cable devices are used in a variety of ways in or on motor vehicles. In fact, this is usually due to the fact that the installation spaces inside a motor vehicle are often rugged and small in volume, so that a flexible mechanical connection between the actuating element and the functional housing must be provided. This flexible mechanical connection is provided by the Bowden cable, which, for this purpose, is equipped with the core and the sheath enclosing the core. This allows the required mechanical force to be transmitted from the actuating element to the functional housing via the core (and sometimes also via the sheath).

The actuating element can be any element inside or on a motor vehicle that performs an adjustment movement. This is not necessarily and by way of example the motor vehicle door handle described above. The actuating element can also be an electric motor drive, which, for example, transmits a linear or rotational movement to the functional housing via the Bowden cable. The functional housing as such is also designed only by way of example as a motor vehicle latch housing. It could also just as well be the housing of a window raising drive, the housing for mirror adjustment or other functional housings that convert the mechanical adjustment movement of the actuating element into a specific function.

In the case of the motor vehicle latch housing as a functional housing, a locking mechanism located inside the motor vehicle latch housing can be opened in this way via the motor vehicle door handle. In principle, it is also conceivable in this context that the actuating element is equipped as an electric motor drive, which exerts a closing movement via the Bowden cable on the locking mechanism in question inside the motor vehicle latch housing.

In the event that the functional housing is the housing of a window raising drive, the mechanical adjustment movement of the actuating element, for example an electric motor drive, transmitted via the Bowden cable is in this case converted into a raising or lowering movement of a window pane. A similar approach is used for mirror adjustment, where the Bowden cable ensures the desired transmission of the adjustment movement to the functional housing and thus to the mirror in the example case.

Due to the arrangement of the automotive Bowden cable device in question in or on the motor vehicle, the conditions prevailing there must be taken into account. On the one hand, this requires robust and reliable functionality and, on the other hand, that the environmental conditions prevailing there, such as dust, moisture, etc., do not lead to functional impairments. Typically, varying temperatures in the range of up to −40° C. and up to +60° C. or +80° C. must also be managed.

For this reason, it is particularly important to achieve a sealing coupling between the Bowden cable and the functional housing using the Bowden cable end piece. For this purpose, the Bowden cable end piece described in DE 10 2018 105 550 A1 is designed in several parts and has a connecting part and a sealing part. The connecting part ensures engagement between the sheath of the Bowden cable and a motor vehicle locking component that transmits the actuating force. The sealing part is used to create a sealing engagement with an inner edge of an installation opening or insertion opening to seal the housing interior of the functional housing to the outside.

The further prior art according to DE 10 2018 119 219 A1 is located in a comparable context and relates to a cover for a component of a functional part of a motor vehicle door. This is intended to provide a better fit for a seal. For this purpose, the cover for the component of the functional component of the motor vehicle door is equipped with a main body and a seal. The main body forms a covering surface for closing an opening of a component and at least one peripheral edge region having a contact surface is formed on the main body. The seal has a resilient sealing material and is provided on the contact surface of the edge region.

The generic prior art according to DE 10 2024 106 669 A1 relates to an actuation system for coupling to a lock. A cover plate is realized that has a retaining mechanism or holder for the core of the Bowden cable. This is intended to prevent the core from being inserted into the insertion opening if it sags. However, lateral movement is permitted.

The prior art has proven itself in principle, but still offers room for further improvement. In fact, the generic teaching already works with a guide for the core end piece of the Bowden cable inside the Bowden cable end piece. However, the problem still remains that possible torsion of the core within the sheath of the Bowden cable cannot be prevented. Such torsion can occur depending on the design of the actuating element and are transmitted to the lever inside the functional housing in known Bowden cable devices. If the lever is made of plastics material, for example, this can lead to damage or even complete destruction of the lever; in any case, functional impairments are possible. This is where the invention steps in.

The invention is based on the technical problem of further developing such an automotive Bowden cable device in such a way that the functional reliability is increased, while at the same time having a simple mechanical structure and taking into account a sealed design.

To solve this technical problem, a generic automotive Bowden cable device is characterized in the scope of the present application in that the inner guide in the Bowden cable end piece is designed as a constrained guide that acts on both sides of the core end piece and prevents the core from rotating.

According to the invention, the Bowden cable end piece is therefore equipped with a special inner guide, which acts as a constrained guide for the core end piece. The constrained guide acts on both sides of the core end piece and thus prevents any rotations of the core. This generally makes it possible to prevent rotations of the core relative to the sheath of the Bowden cable during any adjustment movements. In this way, any splicing of the core, which is typically made up of twisted steel strands, is avoided. This also ensures that any rotational movements of the core are not transmitted to the lever coupled thereto and protruding from the functional housing. This means that the lever is not damaged on the one hand and on the other hand it can be operated with relatively little force. These are the main advantages.

According to an advantageous embodiment, in order to realize the constrained guide inside the Bowden cable end piece, the design is usually such that the core end piece is equipped with guide stops on both sides in its longitudinal direction. The guide stops on both sides can interact with corresponding guide walls of the inner guide in the Bowden cable end piece in the sense of constrained guide. This means that due to the guide stops on both sides and opposite each other, the core end piece is at least partially cuboid or angular in cross section.

As a result, the constrained guide inside the Bowden cable end piece can be easily realized and implemented by having the guide stops on both sides of the core end piece rest against the corresponding and also opposite guide walls as components of the inner guide in the Bowden cable end piece. In this case, the guide walls form the inner guide in the Bowden cable end piece. With the help of the constrained guide realized in this way, movements of the core relative to the sheath or the Bowden cable end piece are limited to linear movements, namely in a direction that is determined by the course of the guide stops in the sense of the constrained guide and the guide walls interacting therewith. Rotations of the core are suppressed during this process. This means that a linear adjustment movement can be properly transmitted to the lever protruding from the functional housing by means of the core of the Bowden cable.

Because the lever in the case of a motor vehicle latch housing is, for example, an actuating lever and, in particular, a release lever for the locking mechanism consisting of a catch and a pawl located inside the motor vehicle latch housing, this provides a functional and permanent solution for actuating the release lever in question. This allows the locking mechanism to be opened as an example. The advantages and effects described naturally also apply to other applications discussed in the introduction to the description.

In addition, it has proven to be useful if the core end piece has an opening for engagement of the protruding lever from the functional housing. With the help of this opening, the core end piece is threaded onto the lever protruding opposite the functional housing in the region of the Bowden cable insertion opening during the installation of the Bowden cable end piece on the functional housing.

In order to facilitate this process overall, the core end piece is usually also equipped with a half-collar on the front. This half-collar makes it easier to thread the lever end into the opening during the installation of the Bowden cable end piece. This means that during the installation of the Bowden cable end piece on the functional housing, the end of the lever or the lever end is threaded into the opening in question in the core end piece. This threading process is supported and facilitated by the front half-collar on the core end piece of the core.

For this purpose, the design is further such that the half-collar surrounds the opening as a center in the sense of a semicircular ring. This means that in this case the opening functions as the center or midpoint of a semicircle, which is described by the half-collar formed as a semicircular ring. This facilitates the threading process because the upright lever end moves into the half-collar or semicircular ring during installation and is deflected with its help in the direction of the opening in the center of the semicircular ring. At the end of this process, the lever end is threaded into the opening of the core end piece.

The core end piece is generally designed to be loose compared to the core of the Bowden cable. In order to couple the core end piece to the core of the Bowden cable, the core piece is generally equipped with a nipple receptacle, which at least partially encloses an end nipple of the core of the Bowden cable. This means that in order to install the core end piece on the core of the Bowden cable, the end nipple of the core of the Bowden cable is inserted into the nipple receptacle. Because the nipple receptacle at least partially encloses the end nipple in question, a detachable coupling is realized between the core of the Bowden cable on the one hand and the core end piece on the other. This allows linear movements of the core to be transmitted to the core end piece.

The Bowden cable end piece is usually designed in two parts, a guide part and a sealing part. The guide part and the sealing part are usually made of different materials. While the guide part is rigid and is designed, for example, as a plastics material component or a metal component, the sealing part is made of an elastomeric plastics material. In this way, the design can be further made such that the guide part interacts with a frame enclosing the insertion opening in the functional housing during the installation of the Bowden cable end piece. The same applies to the sealing part, which seals the frame and the insertion opening when the Bowden cable end piece is in the installed state on the functional housing. Because the frame encloses the insertion opening in the functional housing, the insertion opening is also sealed by this process and in the installed state of the Bowden cable on the functional housing. As a result, any moisture or dirt can no longer enter the interior of the functional housing via the insertion opening after installation.

Specifically, the design is such that the guide part at one end engages with a first hook in a recess inside the frame. The other end of the guide part, on the other hand, is penetrated by a second hook on the sealing part. This second hook on the sealing part ensures that, when the Bowden cable end piece is in the installed state on the functional housing, the insertion opening in the functional housing is gripped from below with its help. This results in a proper coupling between the guide part and the sealing part on the one hand and, on the other hand, in the sealing part being brought into position and secured to the functional housing with the help of the guide part, while at the same time sealingly covering the insertion opening.

Finally, the procedure is usually such that, when the Bowden cable end piece is in the installed state on the functional housing, the sealing part also closes an insertion opening in the frame for the Bowden cable. This means that when installing the Bowden cable on the functional housing, the first step is to thread the core end piece with its opening onto the lever end. At the same time, the Bowden cable end piece ensures a tight closure of the insertion opening during installation, through which the lever end emerges outside the functional housing. For this purpose, there is a combinatorial effect of the guide part and the sealing part as both components of the Bowden cable end piece.

In this case, the first hook on the guide part and the second hook on the sealing part at opposite ends of the guide part each ensure that the Bowden cable end piece as a whole spans the insertion opening in the functional housing while overlapping and covering it, thus sealing it off. At the same time, the interaction of the first hook on the guide part on the one hand and the second hook on the sealing part on the other hand ensures that, during this process, both components of the Bowden cable end piece, namely the guide part and the sealing part, are coupled to one another and can also be fixed to the functional housing. In this context, the frame enclosing the insertion opening ensures that the sealing part completely encloses this frame when the Bowden cable end piece is in the installed state, thus ensuring particularly effective sealing of the insertion opening in the functional housing.

Finally, the installed state of the Bowden cable end piece is characterized by the fact that, in this installed state, the insertion opening for inserting the Bowden cable in contact with the functional housing is closed by means of the sealing part. This means that no moisture or dirt can penetrate into the functional housing via the frame.

As a result, a Bowden cable device for automotive applications is provided, which, on the one hand, ensures a properly sealed closure of the insertion opening in the functional housing and, on the other hand, ensures proper actuation of a lever protruding from the functional housing. This is primarily achieved by constrained guide for the core of the Bowden cable inside the Bowden cable end piece. These are the main advantages.

The invention is explained in greater detail below with reference to drawings which show only one exemplary embodiment. In the drawings:

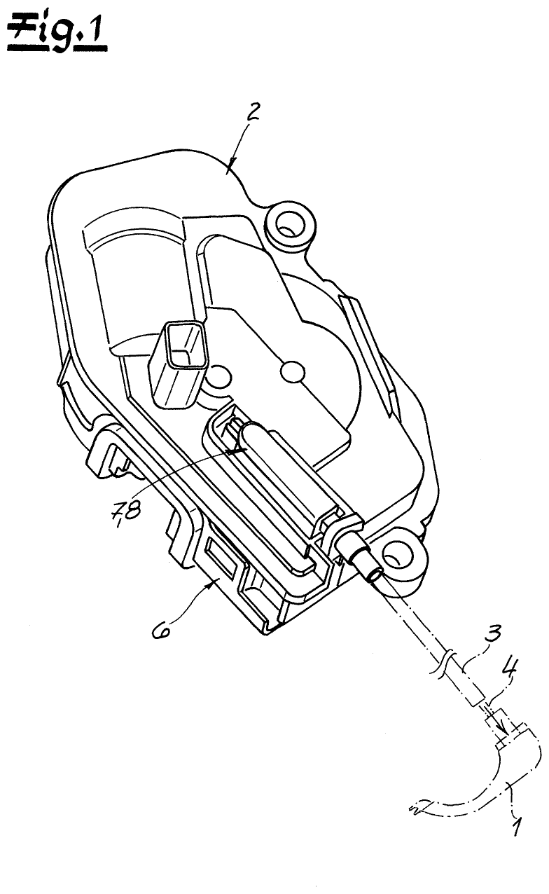

FIG. 1 shows the automotive Bowden cable device in conjunction with the associated functional housing in the installed state,

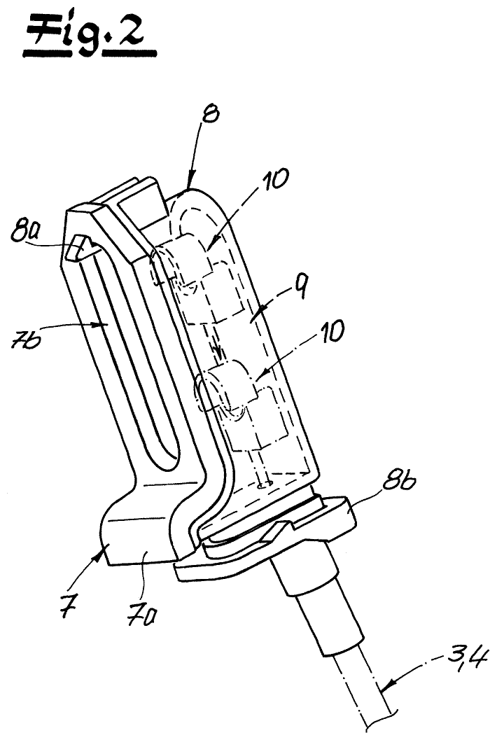

FIG. 2 shows the Bowden cable end piece in detail,

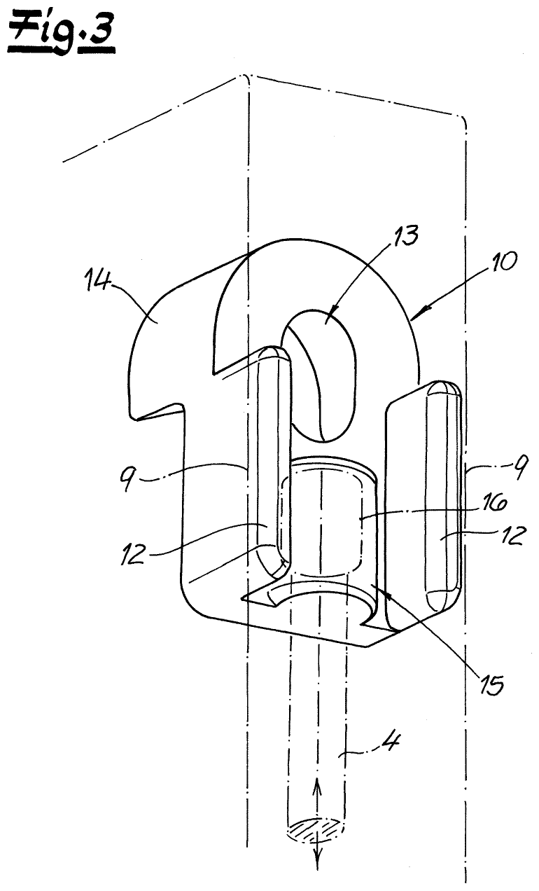

FIG. 3 shows the core end piece in a detailed perspective view,

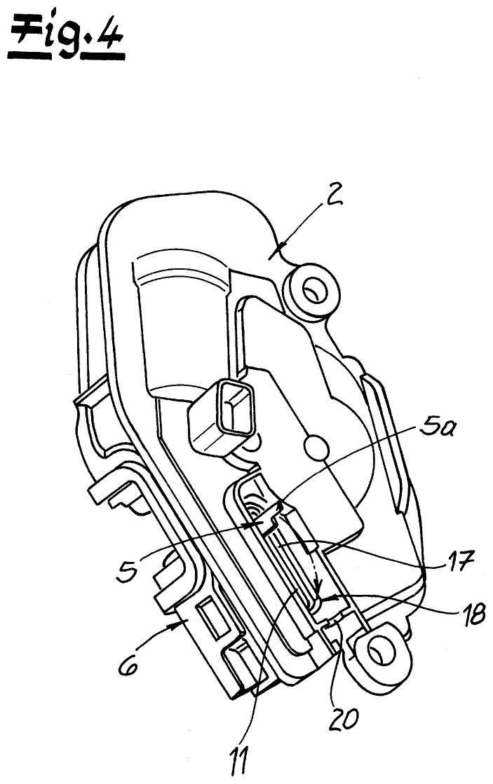

FIG. 4 shows the functional housing with the Bowden cable end piece removed before installation and

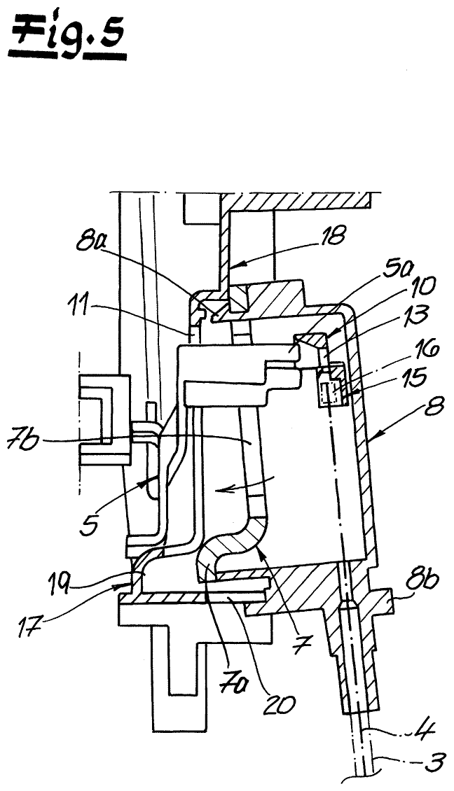

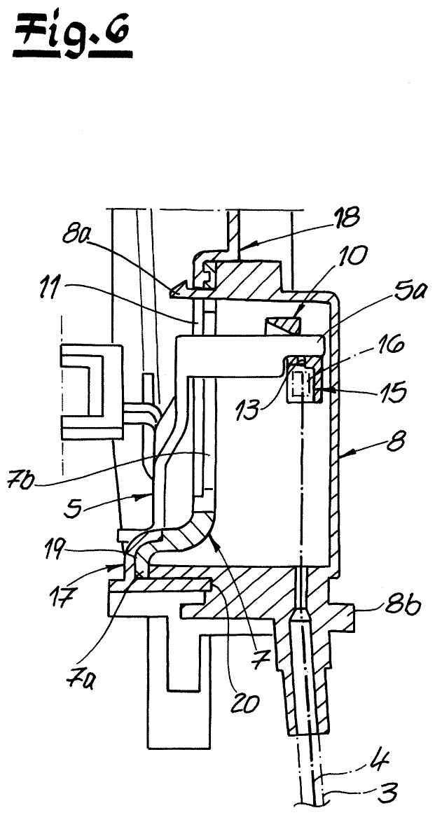

FIGS. 5 and 6 show the installation of the Bowden cable end piece on the functional housing in different phases of installation in a sectional view.

The figures show an automotive Bowden cable device. Said automotive Bowden cable device is used to mechanically couple an actuating element 1, which is merely indicated in FIG. 1, to a functional housing 2. Within the scope of the exemplary embodiment and not in a limiting manner, the actuating element 1 is a mechanical actuating element 1, for example a motor vehicle door handle 1. In principle, the actuating element 1 can also operate using an electric motor. However, this is not shown.

A Bowden cable 3, 4 can be actuated by means of the mechanical actuating element shown or the motor vehicle door handle 1. For this purpose, the Bowden cable 3, 4 has a sheath 3 and a core 4 guided in the sheath 3 and enclosed thereby. In this case, the core 4 may be connected to the actuating element or the motor vehicle door handle 1 in the example case.

In this way, mechanical movements of the motor vehicle door handle 1 can be transmitted, for example by pulling, to the core 4 of the Bowden cable 3, 4. Because the sheath 3 of the Bowden cable 3, 4 is supported on the functional housing 2, the pulling movements initiated by the motor vehicle door handle 1 can be transmitted via the Bowden cable 3, 4 to a lever 5 that can be seen in FIG. 4 and is mounted inside the functional housing 2. Within the scope of the exemplary embodiment, the functional housing 2 is a motor vehicle latch housing 2 that, together with a motor vehicle latch case 6 that can also be seen, overall defines a motor vehicle latch and, according to the exemplary embodiment, a motor vehicle door latch 2, 6.

A locking mechanism consisting of a catch and a pawl, not expressly shown, can be mounted inside the motor vehicle door latch 2, 6 and specifically on the motor vehicle latch case or latch case 6. In the example case, the locking mechanism in question can be opened using lever 5. For this purpose, the lever 5 may be designed as a release lever 5. In order to open the locking mechanism, the lever or release lever 5 must perform a pivoting movement that substantially corresponds to a linear or arcuate movement of a lever end 5a of the lever or release lever 5, which lever end can be seen in FIG. 4. This is indicated by an arrow in FIG. 4.

In order to implement this linear to slightly curved movement of the lever end 5a and thus, in the example case, to be able to realize the locking mechanism inside the motor vehicle latch 2, 6 or the motor vehicle latch housing 2, the core 4 of the Bowden cable 3, 4 is coupled to the lever end 5a in question. The previously described pulling movements of the core 4, triggered by a pivoting movement of the motor vehicle door handle 1, are now transmitted from the core 4 to the lever end 5a and thus to the lever or release lever 5, so that the desired opening of the locking mechanism inside the functional housing or the motor vehicle latch housing 2 occurs.

Of particular importance is a media-tight connection of the Bowden cable 3, 4 to the functional housing or motor vehicle latch housing 2. For this purpose, the Bowden cable device described in detail is equipped with a Bowden cable end piece 7, 8, which is shown in perspective in FIG. 2. The Bowden cable end piece 7, 8 in turn has an inner guide 9 for an additional and separate core end piece 10, which is shown in FIG. 3. During the installation of the Bowden cable end piece 7, 8, the core end piece 10 overlaps the upright end or lever end 5a of the lever or release lever 5 protruding from the functional housing or motor vehicle latch housing 2. In fact, said lever end 5a penetrates through an insertion opening 11 for the Bowden cable 3, 4 in the functional housing or motor vehicle latch housing 2 (cf. FIG. 4).

According to the invention, the previously referred to and inner guide 9 inside the Bowden cable end piece 7, 8 is now designed as a constrained guide for the core end piece 10 of the Bowden cable 3, 4. By means of this constrained guide, rotations of the Bowden cable 3, 4 and in particular its core 4 relative to the surrounding sheath 3 are prevented. For this purpose, the inner guide 9 in the Bowden cable end piece 7, 8 acts on both sides of the core end piece 10.

For this purpose, the guide 9 inside the Bowden cable end piece 7, 8 consists of opposing guide walls 9. The opposing guide walls 9 inside the Bowden cable end piece 7, 8 correspond to guide stops 12 on both sides of the core end piece 10 in its longitudinal extension. In fact, the design is such that the core end piece 10 rests against and can be moved along the corresponding guide walls 9 inside the Bowden cable end piece 7, 8 by means of its two opposing guide stops 12. The mutual contact between the guide stops 12 and the corresponding guide walls 9 results in the described constrained guide and in the fact that any rotations of the core 4 connected to the core end piece 10 and also of the core end piece 10 as a whole are avoided.

As a result, only a pulling movement (or pushing movement) in a linear direction, indicated by a double arrow in FIG. 3, can be exerted on the core end piece 10 by means of the core 4 of the Bowden cable 3, 4, which pulling movement (or pushing movement) is transmitted to the upright end 5a of the lever 5 via an opening 13 additionally provided in the core end piece 10. For this purpose, during the installation of the Bowden cable end piece 7, 8 together with the core end piece 10 on the functional housing 2, the lever end 5a is threaded through the opening 13 in the core end piece 10, as will be explained in more detail below.

From FIG. 3 it can be seen that the core end piece 10 is not only equipped with the aforementioned opening 13 for engagement of the lever 5 protruding from the functional housing 2 or its lever end 5a. The core end piece 10 also has a front half-collar 14, which in the exemplary embodiment is designed as a semicircle and surrounds the opening 13 as a center in this sense. This means that the center of the half-collar 14, which is designed as a semicircular ring, coincides with the opening 13 for receiving the lever end 5a of the release lever 5. As a result, during the installation of the Bowden end piece 7, 8, the front half-collar 14 ensures that the lever end 5a is guided by the half-collar 14 into the opening 13 and is threaded through the opening 13.

In this way, linear pulling movements (or pushing movements) exerted on the core end piece 10 and predetermined by the constrained guide are transmitted to the lever end 5a of the lever 5 and thus to the release lever 5 as a whole according to the double arrow in FIG. 3, so that in the example case the locking mechanism can be opened inside the functional housing or motor vehicle latch housing 2. This causes the lever 5, which is pivotably mounted in the latch housing 2, to pivot and open the locking mechanism.

For the detachable connection of the Bowden cable 3, 4 to the core end piece 10, the core end piece 10 is equipped with a nipple receptacle 15. The nipple receptacle 15 is designed such that it at least partially encloses an end nipple 16 at the end of the core 4 of the Bowden cable 3, 4. As soon as the end nipple 16 on the core 4 is inserted into the nipple receptacle 15, the described pulling movements (or pushing movements) can be transmitted from the core 4 of the Bowden cable 3, 4 to the core end piece 10 and lead to its linear movement as a result of the constrained guide.

If one now looks at the Bowden cable end piece 7, 8, which is substantially shown in a perspective view in FIG. 2, one can see that the Bowden cable end piece 7, 8 is designed in two parts with a guide part 7 and a sealing part 8. While the guide part 7 is generally a plastics material component or metal component or combinations thereof, the sealing part 8 is made of an elastomeric plastics material. The sealing part 8 therefore primarily performs the function of sealing the insertion opening 11 in the functional housing or motor vehicle latch housing 2 for the Bowden cable 3, 4. This is described in more detail below.

From FIG. 2 in conjunction with the sectional views in FIGS. 5 and 6, it can be seen that the guide part 7 interacts with a frame 17, 18 enclosing the insertion opening 11 in the functional housing 2 during the installation of the Bowden cable end piece 7, 8. A comparison of FIGS. 1 and 4 makes it clear that two frames 17, 18 are provided at this point, namely an inner frame 17 and an outer frame 18. It can be seen that the sealing part 8 substantially overlaps the inner frame 17 and more or less fills the outer frame 18 in the installed state, as shown in FIG. 1. As a result, the insertion opening 11 in the functional housing or motor vehicle latch housing 2 is perfectly closed and sealed as soon as the Bowden cable end piece 7, 8 is installed.

The installation of the Bowden cable end piece 7, 8 can best be understood with reference to the two sectional views in FIGS. 5 and 6. FIG. 5 shows the initial state of the installation, whereas FIG. 6 shows the final state of the installation of the Bowden cable end piece 7, 8.

For this purpose, the guide part 7 is equipped at one end with a first hook 7a. During installation, the first hook 7a in question engages in a recess 19 in the interior of the frame 17, 18, specifically in the recess 19 located at the Bowden cable end of the inner frame 17 between the inner frame 17 and the outer frame 18. Here, an insertion opening 20 for the Bowden cable 3, 4 in the outer frame 18 is also shown and can be seen, in particular in FIG. 4.

In the first stage of installation of the Bowden cable end piece 7, 8 shown in FIG. 5, the guide part 7 together with the sealing part 8 is hooked into one end of the insertion opening 11, specifically the end opposite the recess 19. As a result, the end in question of the insertion opening 11 functions as a pivot bearing for the combinatorial movement of the guide part 7 together with the sealing part 8. For this purpose, a second hook 8a is realized at this point, which is a component of the sealing part 8. This means that while the first hook 7a belongs to the guide part 7, the second hook 8a is located at the front end of the Bowden cable end piece 7, 8, namely on the sealing part 8.

From FIG. 2, it can be seen that the guide part 7 is equipped with a central longitudinal bore 7b through which the lever end 5a of the lever 5 protruding from the functional housing 2 through the insertion opening 11 extends and can extend. As a result, during the installation of the Bowden cable end piece 7, 8, said lever end 5a is simultaneously threaded into the opening 13 of the core end piece 10.

In fact, the pivoting process of the Bowden cable end piece 7, 8 indicated and beginning in FIG. 5 about the pivot bearing formed at the front end inside the insertion opening 11 causes the core end piece 10 guided on the guide walls 9 inside the Bowden cable end piece 7, 8 to reach the lever end 5a with its opening 13 or the lever end 5a to be threaded into the opening 13 during this process. This process is supported by the half-collar 14 of the core end piece 10, which surrounds the opening 13 as a center.

When moving from FIG. 5 to FIG. 6, the pivoting movement about the previously defined pivot bearing at one end of the insertion opening 11 ensures that the first hook 7a on the guide part 7 engages in the recess 19 inside the frame 17, 18 and specifically between the inner frame 17 and the outer frame 18. At the same time, the Bowden cable 3, 4 is threaded into the insertion opening 20. The sealing part 8 now ensures, in the installed position shown in FIG. 6, that an extension 8b of the sealing part 8 closes the insertion opening 20 in this installed state. This results in an overall tight coupling of the Bowden cable 3, 4 to the functional housing or motor vehicle latch housing 2. At the same time, during this process, the core end piece 10 is coupled to the lever end 5a of the lever or release lever 5 protruding opposite the insertion opening 11 in the functional housing 2. As a result, immediately after completion of the installation process, pulling movements (or pushing movements) of the core 4 relative to the sheath 3 are transmitted directly to the lever or release lever 3 and implemented inside the functional housing or motor vehicle latch housing 2 in such a way that the locking mechanism is thereby opened.

In contrast to the metal latch case 6 according to the embodiment, the functional housing 2 is made of plastics material. This of course also applies to the respective frames 17, 18. The core end piece 10 is generally also a plastics material component that can be easily coupled to the Bowden cable 3, 4 by inserting the end nipple 16 at the end of the core 4 into the corresponding nipple receptacle 15 and generally holding it captively and non-displaceably therein. The individual components can therefore be connected to each other step by step and the Bowden cable 3, 4 can then be coupled to the functional housing 2. Accordingly, the functional housing or motor vehicle latch housing 2 and thus the motor vehicle latch 2, 6 as a whole can be installed initially and before the installation of the Bowden cable 3, 4 inside a motor vehicle door (not shown). The Bowden cable 3, 4 can then be coupled to the functional housing or motor vehicle latch housing 2 according to the exemplary embodiment, and the coupling simultaneously ensures its proper function. These are the main advantages.

### LIST OF REFERENCE SIGNS

1 actuating element, motor vehicle door handle
2 functional housing, motor vehicle latch housing
3,4 Bowden cable
3 sheath
4 core
5 lever, release lever
5a lever end
6 latch case, motor vehicle latch case
2,6 motor vehicle door latch
7 guide part
7a first hook
8 sealing part
8a second hook
8b extension
7,8 Bowden cable end piece
9 inner guide, constrained guide, guide walls
10 core end piece
11 insertion opening
12 guide stops
13 opening
14 front half-collar
15 nipple receptacle
16 end nipple
17 inner frame
18 outer frame
17, 18 frame
19 recess
20 insertion opening

1. An automotive Bowden cable device for mechanically coupling an actuating element to a functional housing the automotive Bowden cable device comprising:
a Bowden cable having:
a core,
a core end piece having two sides, and
a sheath, and
a Bowden cable end piece configured to sealingly couple the Bowden cable to the functional housing, the Bowden cable end piece having an inner guide for the core end piece of the Bowden cable,
wherein the core end piece engages over an upright end of a lever protruding from the functional housing in a region of a first insertion opening of the Bowden cable in the functional housing during an installation of the Bowden cable end piece, and
wherein the inner guide of the Bowden cable end piece is a constrained guide that acts on both of the two sides of the core end piece and prevents the core from rotating
wherein the Bowden cable end piece includes a guide part and a sealing part, and
wherein the sealing part sealingly engages the functional housing to seal the guide part on the functional housing.

2. The automotive Bowden cable device according to claim 1, wherein the inner guide includes guide walls, wherein the core end piece includes guide stops on both sides, and wherein the guide stops are configured to interact with corresponding guide walls of the inner guide of the Bowden cable end piece.

3. The automotive Bowden cable device according to claim 1, wherein the core end piece includes an opening configured to engage with the protruding lever from the functional housing.

4. The automotive Bowden cable device according to claim 3, wherein the upright end of the protruding lever includes a threading, and wherein the core end piece includes a front half-collar configured to facilitate the threading of the upright end of the protruding lever into the opening of the core end piece during the installation of the Bowden cable end piece.

5. The automotive Bowden cable device according to claim 4, wherein the half-collar surrounds the opening as a center in the sense of a semicircular ring.

6. The automotive Bowden cable device according to claim 1, wherein the core of the Bowden cable includes an end nipple, and wherein the core end piece includes a nipple receptacle at least partially enclosing the end nipple of the core of the Bowden cable.

7. (canceled)

8. The automotive Bowden cable device according to claim 1, wherein the functional housing further includes at least one frame enclosing the first insertion opening, and wherein the guide part is configured to interact with the at least one frame during the installation of the Bowden cable end piece.

9. The automotive Bowden cable device according to claim 8,
wherein the at least one frame includes a first end with an interior recess and a second end,
wherein the guide part includes a first hook,
wherein the sealing part includes a second hook, and
wherein the first hook of the guide part engages the first end in the interior recess, while the second end is penetrated by the second hook of the sealing part such that the second hook grips the first insertion opening of the functional housing from below in an installed state.

10. The automotive Bowden cable device according to claim 9, wherein the at least one frame includes a second insertion opening for the Bowden cable, and wherein the sealing part, in the installed state on the functional housing, closes the second insertion opening.

11. The automotive Bowden cable device according to claim 1, wherein the actuating element is a motor vehicle door handle.

12. The automotive Bowden cable device according to claim 1, wherein the functional housing is a motor vehicle latch housing.

13. The automotive Bowden cable device according to claim 1, wherein the guide part is made of metal.

14. The automotive Bowden cable device according to claim 1, wherein the sealing part is made of elastomeric plastic.

15. The automotive Bowden cable device according to claim 1, wherein the guide part includes a central longitudinal bore through which the upright end of the protruding lever extends.
